(19) United States
(12) Patent Application Publication
(10) Pub. No.: US 2017/0310428 A1
(43) Pub. Date: Oct. 26, 2017

(54) LINE CARD AND LINE CARD CONTROL METHOD

(71) Applicant: FUJITSU LIMITED, Kawasaki-shi (JP)

(72) Inventors: Kunihiko YANAGIKUIDA, Kawasaki (JP); Hiroshi lizuka, Kawasaki (JP)

(73) Assignee: FUJITSU LIMITED, Kawasaki-shi (JP)

(21) Appl. No.: 15/484,494

(22) Filed: Apr. 11, 2017

(30) Foreign Application Priority Data
Apr. 20, 2016 (JP) 2016-084291

(51) Int. Cl. H04L 1/18; H04L 1/00

(52) U.S. Cl. CPC H04L 1/1845; H04L 1/0041

(57) ABSTRACT

There is provided a line card configured to mount a module in which a signal transmitted on a line is processed, the line card including a memory, and a processor coupled to the memory and the processor configured to receive information on transmission quality of the signal to be transmitted through the module to be mounted on the line card, extract a combination satisfying the transmission quality among combinations of error correction processing schemes applicable to the module and a framer circuit for performing a signal processing for the signal to be transmitted, and estimate a combination of a range in which temperatures of each of the module and the framer circuit do not exceed a predetermined temperature when the module and the framer circuit are operated by applying the error correcting processing schemes of the combination extracted.

### CROSS-REFERENCE TO RELATED APPLICATION

This application is based upon and claims the benefit of priority of the prior Japanese Patent Application No. 2016-084291, filed on Apr. 20, 2016, the entire contents of which are incorporated herein by reference.

### FIELD

The embodiments discussed herein are related to a line card within an optical transmission device.

### BACKGROUND

In recent years, with the increase of Internet traffic, there have been demands for large capacity, miniaturization, and cost reduction in an optical communication system, and various types of optical pluggable (detachable) modules (hereinafter, simply referred to as “modules”) are mounted on each line card within an optical transmission device. The various types of modules are, for example, a 10G small form-factor pluggable (XFP) module and a 100G form-factor pluggable (CFP) module. Each module mounted on the line card processes a signal transmitted through the module connected with a transmission line.

As to the structure of a cage on which a module is mounted and the shape of the module, for example, INF-8077i is defined as a standard specification in the case of XFP, and CFP-MSA is defined as a standard specification in the case of CFP. Therefore, a module in compliance with a standard function may be detachably mounted on a mounting port in the cage.

However, each module includes various types of modules depending on support states such as a transmission distance and internal functions. For example, in the case of XFP, the power consumption amount thereof is in the range of, for example, 1 Watt (W) to 6 W, depending on the specifications. In the case of CFP, the power consumption amount thereof is in the range of, for example, 8 W to 32 W, depending on specifications. Further, there is a tendency that the power consumption increases as the functionality of a module becomes high.

As a technique for supporting a longer transmission distance, a process of correcting a bit error for a signal received in a reception terminal of a transmission line is performed by applying an error correction code. A circuit module, such as a large scale integration (LSI) performing such error correcting process performs a more complicated operation as the error correction capability improves. For this reason, the power consumption of the circuit module that performs the error correcting process tends to increase as the gate size increases.

There is known a technique for enlarging the range of device guarantee while providing maintenance and cost superiority to the optical transmission device and widening the choice options of optical pluggable modules that can be used (see, for example, Patent Document 1).

There is known a monitoring control device capable of estimating, in advance, an environment temperature after triggering of a mounted module, before the triggering of the mounted module (see, for example, Patent Document 2).

Related technologies are disclosed in, for example, Japanese Laid-Open Patent Publication No. 2007-096640 that is the Patent Document 1 and No. 2014-235721 that is the Patent Document 2.

### SUMMARY

According to an aspect of the invention, a line card is configured to mount a module in which a signal transmitted on a line is processed, the line card includes a memory, and a processor coupled to the memory and the processor configured to receive information on transmission quality of the signal to be transmitted through the module to be mounted on the line card, extract a combination satisfying the transmission quality among combinations of error correction processing schemes applicable to the module and a framer circuit for performing a signal processing for the signal to be transmitted, and estimate a combination of a range in which temperatures of each of the module and the framer circuit do not exceed a predetermined temperature when the module and the framer circuit are operated by applying the error correcting processing schemes of the combination extracted.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an example of an optical transmission device;

FIG. 2 is an explanatory view schematically illustrating an example of a line card;

FIG. 3 is a view for describing an example of a thermal coefficient table;

FIG. 4 is a view for describing an example of a power consumption amount table;

FIG. 5 is a view for describing an example of a specified temperature table;

FIG. 6A is a flowchart for describing a process by a card controller according to the present disclosure;

FIG. 6B is a flowchart for describing a process by a card controller according to the present disclosure;

FIG. 6C is a flowchart for describing a process by a card controller according to the present disclosure;

FIG. 6D is a flowchart for describing a process by a card controller according to the present disclosure;

FIG. 6E is a flowchart for describing a process by a card controller according to the present disclosure;

FIG. 7A is a flowchart for describing an exemplary process by an estimation unit;

FIG. 7B is a flowchart for describing an exemplary process by an estimation unit; and

FIG. 8 is a flowchart for describing an example of an extracting method in an FEC scheme satisfying a transmission quality.

### DESCRIPTION OF EMBODIMENTS

The optical pluggable modules mounted on a line card within an optical transmission device have different power consumption amounts depending on the support states such as an optical transmission distance and internal functions. Further, although the scheme of correcting an error (forward error correction (FEC) scheme) in an LSI or a module may be selected according to a transmission distance, the power consumption amount increases when the FEC scheme with a high error correction capability is selected.

Therefore, in a case where a module with the high power consumption and an FEC scheme with the high correction capability are combined with each other to be used for the line card, the environment temperature inside the transmission device may exceed a specified temperature when a plurality of modules is mounted on a line card and triggered.

Hereinafter, with reference to the drawings, descriptions will be made on an embodiment of a technology for enabling a mounting arrangement suitable for practical operation by performing a temperature monitoring on the line card and selecting FEC schemes in a line card on which various types of pluggable modules are mounted.

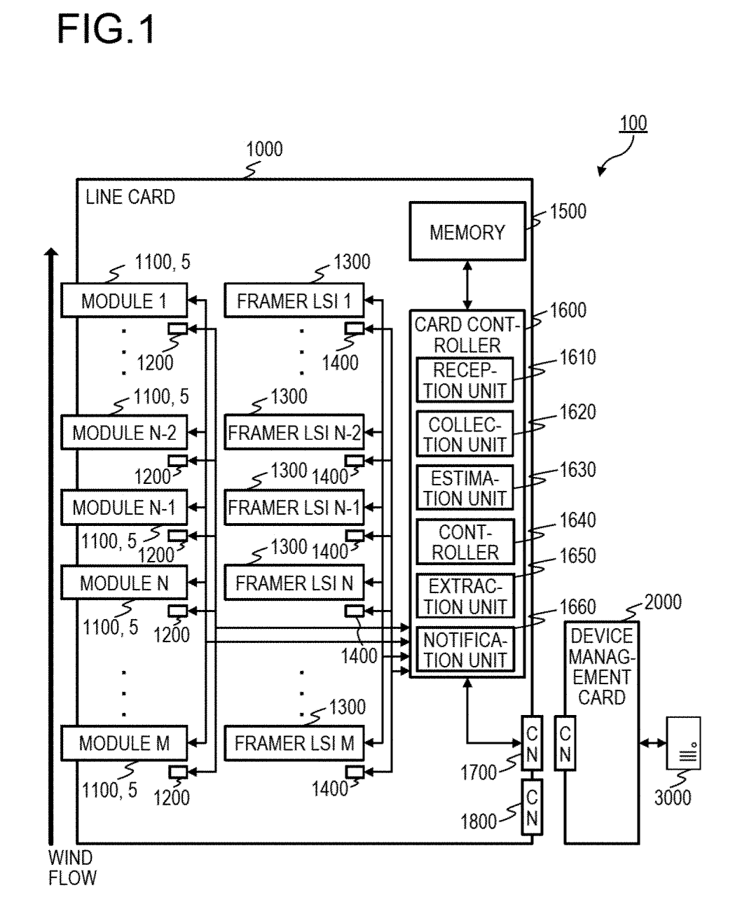

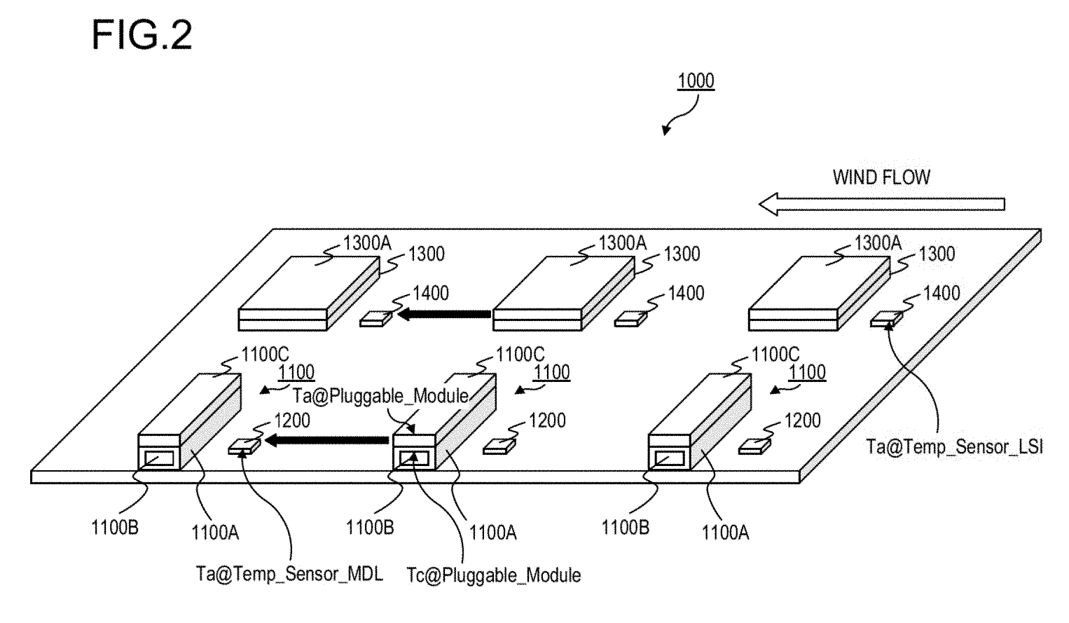

FIG. 1 is a diagram for describing an example of an optical transmission device. FIG. 2 is an explanatory view schematically illustrating an example of a line card. An optical transmission device 100 illustrated in FIG. 1 includes a line card 1000, a device management card 2000, and a management terminal 3000.

The line card 1000 enables mounting of, for example, M XFP modules, and includes a mounting portion 1100, a temperature sensor 1200, a framer LSI 1300, a temperature sensor 1400, a connection connector 1700, a power supply connector 1800, a memory 1500, and a card controller 1600. A module 5 is mounted on the mounting portion 1100, and the mounting portion 1100 includes a cage 1100A having a mounting port 1100B which detachably mounts the module 5, and a heat sink 1100C arranged on the upper surface of the cage 1100A (see, for example, FIG. 2; however, FIG. 2 does not illustrate the module 5). The heat sink 1100C is a heat radiation component having heat radiation pins that radiate heat of the module 5 mounted on the mounting port 1100B.

The M framers LSI 1300 are mounted on the line card 1000. Each framer LSI 1300 has a function of efficiently grouping various client signals and converting the signals into a signal frame format of an optical transmission network having an error correcting function. As illustrated in FIG. 2, the framer LSI 1300 includes a heat sink 1300A on the upper surface thereof. The heat sink 1300A is a heat radiation component having heat radiation pins that radiate heat of the framer LSI 1300.

The module 5 has a soft decision (SD) FEC function and enables a soft decision error correcting process. Meanwhile, the framer LSI 1300 has a hard decision (HD) FEC function and enables a hard decision error correcting process.

The temperature sensor 1200 is arranged near each corresponding cage 1100A to measure an environment temperature of a windward side and detect the environment temperature as a surrounding environment temperature Tₐ@Temp_Sensor_MDL of the cage 1100A. Hereinafter, the surrounding environment temperature Tₐ@Temp_Sensor_MDL of the cage 1100A, which is measured by the temperature sensor 1200 will be referred to as “Tₐ@Temp_Sensor_MDL.” The temperature sensor 1400 is arranged near each corresponding framer LSI 1300 to measure an environment temperature of a windward side and detect the environment temperature as a surrounding environment temperature Tₐ@Temp_Sensor_LSI of the framer LSI 1300. Hereinafter, the surrounding environment temperature Tₐ@Temp_Sensor_LSI of the cage 1100A, which is measured by the framer LSI 1300 will be referred to as “Tₐ@Temp_Sensor_LSI.”

The connection connector 1700 is a connector to be connected to the device management card 2000. The power supply connector 1800 is a connector to be connected to a power supply (not illustrated). The card controller 1600 entirely controls the line card 1000. The card controller 1600 collects the surrounding environment temperature Tₐ@Temp_Sensor_MDL from the temperature sensor 1200 for each cage 1100A and the surrounding environment temperature Tₐ@Temp_Sensor_LSI from the temperature sensor 1400 for each framer LSI 1300. Also, the card controller 1600 notifies the management terminal 3000 of information on for example, usable mounting ports or FEC schemes.

The card controller 1600 is configured to include a processor that reads out various programs from the memory 1500 and executes various processes as functions based on the programs. The card controller 1600 includes, as functions, a reception unit 1610, a collection unit 1620, an estimation unit 1630, a controller 1640, an extraction unit 1650, and a notification unit 1660. The reception unit 1610 receives information on a transmission quality required for a port to be added, from the management terminal 3000. The collection unit 1620 collects temperature information from the module 5, the temperature sensor 1200, the framer LSI 1300, and the temperature sensor 1400. The extraction unit 1650 extracts, from combinations of SD-FEC scheme types operated by a module to be connected to the port to be added and HD-FEC scheme types operated by a framer LSI, a combination exceeding (satisfying) the transmission quality. When it is assumed that the module and the framer LSI are operated in the extracted combination, the estimation unit 1630 estimates whether the module and the framer LSI exceed the specified temperature. The controller 1640 controls the FEC schemes operated by the module and the famer LSI.

As described above, the card controller 1600 according to the present disclosure may estimate the combinations of the FEC schemes operated by the framer LSI and the pluggable module in the range in which an environment temperature within the device does not exceed the specified temperature.

Next, a process by the line card according to the present disclosure will be described. An environment temperature directly above the heat sink 1100C mounted on each module will be referred to as “Tₐ@Pluggable_Module.” The module 5 may acquire a module case temperature through a control interface. The module case temperature will be referred to as “T_{c}@Pluggable_Module.” Further, a thermal resistance (C/W) of the cage 1100A and the heat sink 1100C will be referred to as “θ_{ca}@MDL.” A power consumption amount (W) of the module 5 will be referred to as “P@MDL.” The card controller 1600 may calculate the environment temperature Tₐ@Pluggable_Module directly above the heat sink 1100C based on the following equation.

(Tₐ@Pluggable_Module)=(T_{c}@Pluggable_Module)−(θ_{ca}@MDL)*(P@MDL)

Accordingly, the card controller 1600 may acquire, in advance, the surrounding environment temperature Tₐ@Temp_Sensor_MDL of the cage 1100A and the environment temperature Tₐ@Pluggable_Module directly above the heat sink 1100C. Also, the card controller 1600 calculates a difference ΔTₐ@MDL between the surrounding environment temperature Tₐ@Temp_Sensor_MDL of the cage 1100A and the environment temperature Tₐ@Pluggable_Module directly above the heat sink 1100C.

In a case where the thermal resistance θ_{ca}@MDL is acquired in advance, and information on a power consumption amount of a certain module 5 corresponding to the FEC schemes may be acquired, the card controller 1600 may estimate the module case temperature T_{c}@Pluggable_Module when the module 5 is triggered.

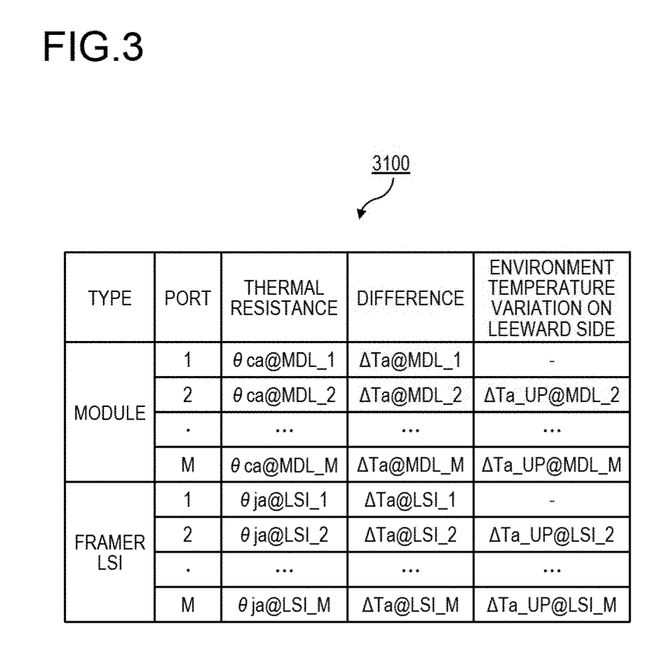

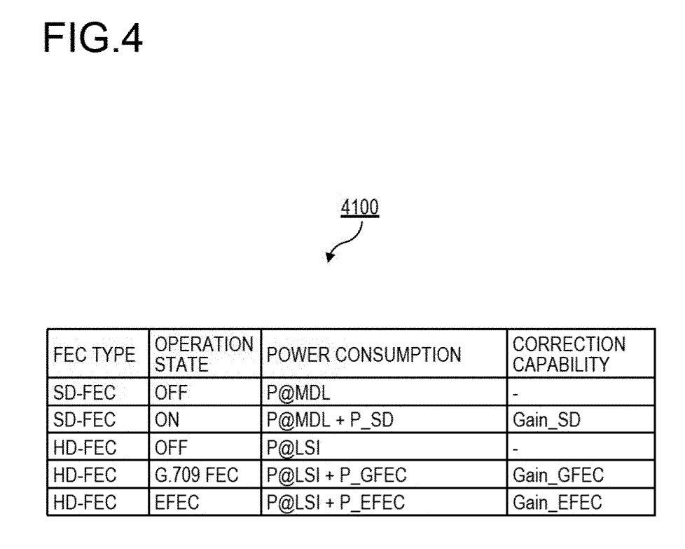

In addition, with respect to an influence of heat generated in the module 5 on the leeward side, the card controller 1600 estimates an environment temperature variation “ΔTₐ_{_}_{UP}@MDL” of a mounting position of a leeward-side module 5. The card controller 1600 estimates the environment temperature variation ΔTₐ_{_}_{UP}@MDL by using the module power consumption amount P@MDL. Here, the relationship between the power consumption amount and the environment temperature variation may be measured in advance and acquired as table information (which will be described later with reference to FIGS. 3 and 4). The relationship between the power consumption amount and the environment temperature variation may be determined by a thermal design simulation.

ΔTₐ_{_}^{UP}@MDL=f(P@MDL)

Similarly, the temperature sensor 1400 is arranged near each corresponding framer LSI 1300 to measure an environment temperature of the windward side and detect the environment temperature as a surrounding environment temperature Tₐ@Temp_Sensor_LSI of the framer LSI 1300. An environment temperature directly above the heat sink 1300A mounted on the framer LSI 1300 will be referred to as “Tₐ@Framer_LSI.” The framer LSI 1300 may acquire a junction temperature through a control interface. This junction temperature will be referred to as “Tⱼ@Framer_LSI.” Further, a thermal resistance (C/W) of the framer LSI 1300 and the heat sink 1300A will be referred to as “θⱼₐ@LSI.” The power consumption amount (W) of the framer LSI 1300 will be referred to as “P@LSI.” The card controller 1600 may calculate the environment temperature Tₐ@Framer_LSI directly above the heat sink 1300A based on the following equation.

(Tₐ@Framer_LSI)=(Tⱼ@Framer_LSI)−(θⱼₐ@LSI)*(P@LSI)

Therefore, the card controller 1600 may acquire, in advance, the surrounding environment temperature Tₐ@Temp_Sensor_LSI of the framer LSI 1300 and the environment temperature Tₐ@Framer_LSI directly above the heat sink 1300A. Further, the card controller 1600 may calculate the difference ΔTₐ@LSI between the surrounding environment temperature Tₐ@Temp_Sensor_LSI of the framer LSI 1300 and the environment temperature Tₐ@Framer_LSI directly above the heat sink 1300A. In a case where the thermal resistance θⱼₐ@LSI is acquired in advance, and information on a power consumption amount of a certain framer LSI 1300 corresponding to the FEC scheme is acquired, the card controller 1600 may estimate the junction temperature Tⱼ@Framer_LSI when the framer LSI 1300 is triggered.

In addition, with respect to an influence of heat generated in the framer LSI 1300 on the leeward side, the card controller 1600 estimates an environment temperature variation “ΔTₐ_{_}_{UP}@LSI” of a mounting position of a leeward-side framer LSI 1300. The card controller 1600 estimates the environment temperature variation ΔTₐ_{_}_{UP}@LSI by using the power consumption amount P@LSI of the framer LSI 1300. The relationship between the power consumption amount and the environment temperature variation may be measured in advance and acquired as table information (which will be described later with reference to FIGS. 3 and 4). The relationship between the power consumption amount and the environment temperature variation may be determined by a thermal design simulation.

Tₐ@Framer_LSI=f(P@LSI)

Each piece of information (e.g., ΔTₐ, θⱼₐ, θ_{ca}, or ΔTₐ_{_}_{UP}) varies depending on the mounting positions of the module 1100 and the framer LSI 1300 on the line card 1000. Thus, the card controller 1600 acquires each piece of information (e.g., ΔTₐ, θⱼₐ, θ_{ca}, or ΔTₐ_{_}_{UP}) from each of the module 1100 and the framer LSI 1300.

The wind flow on the line card 1000 is not changed by the mounting/unmounting of the module 1100 and the framer LSI 1300. The wind flow is determined by the structure of a cage for the module 5 and is not affected by the presence/absence of a module to be mounted within the cage and the triggering state of the module.

FIG. 3 is a view for describing an example of a thermal coefficient table. The thermal coefficient table 3100 includes items of a type, a port, a thermal resistance, a difference, and a leeward-side environment temperature variation. The type is information representing a module and a framer LSI. The port is information representing port numbers 1 to M for the module 1100 and the framer LSI 1300.

The thermal resistance item of the thermal coefficient table of FIG. 3 represents a thermal resistance amount of each of the module and the framer LSI. The thermal resistance amount of the module 1100 is represented as θ_{ca}@MDL, and the thermal resistance amount of the framer LSI 1300 is represented as θⱼₐ@LSI. Since the thermal resistance amount of the module 1100 and the thermal resistance amount of the framer LSI 1300 at each port are different from each other, a port number is assigned behind θ_{ca}@MDL and θⱼₐ@LSI in the form of “_number” in FIG. 3.

The difference item includes the difference on the side of the module 1100 and the difference on the side of the framer LSI 1300. The difference on the side of the module 1100 is information representing the difference between the temperature of the temperature sensor 1200 arranged near the module 1100 (the surrounding environment temperature) and the environment temperature directly above the heat sink 1100C. The difference on the side of the module 1100 is represented as ΔTₐ@MDL. The difference on the side of the framer LSI 1300 is information representing the difference between the surrounding environment temperature of the framer LSI 1300 and the environment temperature directly above the heat sink 1300A. The difference on the side of the framer LSI 1300 is represented as ΔTₐ@LSI. In FIG. 3, a port number is assigned behind ΔTₐ@MDL and ΔTₐ@LSI in the form of “_number.”

The item of the leeward-side environment temperature variation includes a leeward-side environment temperature variation of the module 1100 side and a leeward-side environment temperature variation of the framer LSI 1300 side. The leeward-side environment temperature variation of the module 1100 side represents an environment temperature variation which is an influence imposed by the heat generated by a windward-side module 5 itself on an adjacent leeward-side module 5. The leeward-side environment temperature variation of the framer LSI 1300 represents an environment temperature variation which is an influence imposed by the heat generated by a windward-side framer LSI 1300 itself on an adjacent leeward-side framer LSI 1300. The leeward-side environment temperature variation of the module 5 side is represented as ΔTₐ_{_}_{UP}@MDL. The leeward-side environment temperature variation of the framer LSI 1300 side is represented as ΔTₐ_{_}_{UP}@LSI. In FIG. 3, a port number is assigned behind ΔTₐ_{_}_{UP}@MDL and ΔTₐ_{_{—UP}}@LSI in the form of “_number.” The Ports 1 of the module 1100 and the framer LSI 1300 have no environment temperature variation because there are no other leeward-side module and framer LSI which are affected by the module 1100 and the framer LSI 1300 of the Ports 1.

FIG. 4 is a view for describing an example of a power consumption amount table. The power consumption amount table 4100 includes items of an FEC type, an operation state, a power consumption amount, and a correction capability. The FEC type is represented by information indicating an SD-FEC mounted in the module 5 and an HD-FEC mounted in the framer LSI 1300.

The power consumption amount table 4100 includes information indicating ON and OFF states as the operational state of the SD-FEC function mounted in the module 5. The power consumption amount table 4100 includes information indicating an OFF state as the operational state of the HD-FEC function mounted in the framer LSI 1300 and standards such as G.709 FEC and EFEC as the operational state (standard) of the HD-FEC function.

The power consumption amount table 4100 includes information indicating a power consumption amount in the ON and OFF states of the SD-FEC function, and the OFF state and the standards of the HD-FEC function. Further, the power consumption amount table 4100 includes information indicating a correction capability amount in the ON and OFF states of the SD-FEC function, and the OFF state and the standards of the HD-FEC function. The correction capability amount is represented by a gain value.

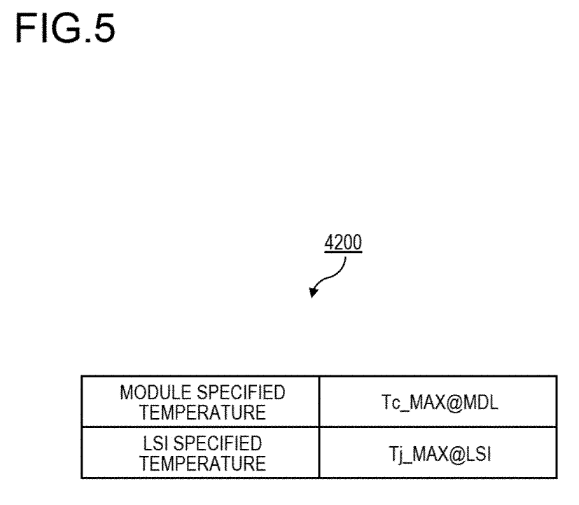

FIG. 5 is a view for describing an example of a specified temperature table. The specified temperature table 4200 provides a module specified temperature “T_{c}_{_}_{MAX}@MDL” acceptable for the operation of the module 5 and an LSI specified temperature “Tⱼ_{_}_{MAX}@LSI” acceptable for the operation of the framer LSI 1300.

The process by the line card 1000 according to the present disclosure, using the data of the various tables of FIGS. 3 to 5 will be described sequentially.

(A1) When a module is newly added, the reception unit 1610 within the line card controller 1600 controlling the line card 1000 receives information on a transmission quality required for a service or a system, from the management terminal 3000. The transmission quality is represented by, for example, a bit error rate (BER).

(A2) The collection unit 1620 collects the module case temperature (T_{c}@Pluggable_Module_1-M) of each module and the surrounding environment temperature (Tₐ@Temp_Sensor_MDL_1-M) of the module. Further, the collection unit 1620 collects the junction temperature (Tⱼ@Framer_LSI_1-M) of each framer LSI 1300 and the surrounding environment temperature (Tₐ@Temp_Sensor_LSI_1-M) of the framer LSI.

(A3) The extraction unit 1650 extracts, from the combinations of SD-FEC scheme types supported by the module 5 side and HD-FEC scheme types supported by the framer LSI 1300 side, a combination satisfying the transmission quality received in (1). A plurality of combinations satisfying the transmission quality may exist.

(A4) The estimation unit 1630 estimates a temperature variation when the module and the framer LSI are triggered in the combinations extracted in the process of (A3), for module-unmounted ports. Further, the estimation unit 1630 determines whether the estimated temperatures of the module and the framer LSI exceed the specified temperature of the specified temperature table 4300. The process s of (A4) will be described in detail later in (B1) to (B10).

(A5) The estimation unit 1630 repeatedly performs the process of (A4) for all the combinations extracted in (A3).

(A6) The estimation unit 1630 repeatedly performs the processes of (A4) and (A5) for all the module-unmounted ports.

(A7) The estimation unit 1630 determines whether an operable port of the module 5 and the framer LSI 1300 exists, based on the results of (A4) to (A6).

(A8) When it is determined in (A7) that a usable port exists, the notification unit 1660 notifies the management terminal 3000 of both the usable port and the combinations of the FEC schemes. An operator selects triggering contents (port and FEC schemes to be used) from the menus.

(A9) The controller 1640 triggers the module and the framer LSI according to instruction contents (a port and FEC scheme to be used) received from the operator in (A8).

(A10) When it is determined in (A7) that there is no usable port, the estimation unit 1630 checks the presence/absence of a margin of the transmission quality, for module-triggered ports. Specifically, the estimation unit 1630 extracts a combination satisfying the transmission quality, other than the SD-FEC scheme and the HD-FEC scheme which are currently being operated. Details will be described in (C1) to (C3). In addition, the transmission quality for a triggered port may be a transmission quality stored in a memory when the corresponding port is added, or may be newly acquired from the operator.

(A11) The estimation unit 1630 performs the process of (A10) for all the module-triggered ports.

(A12) The estimation unit 1630 determines whether a module-triggered port having a margin of the transmission quality exists as a result of (A10) and (A11).

(A13) When it is determined in (A12) that a port having the margin does not exist, the notification unit 1660 notifies the management terminal 3000 of the nonexistence of an addible port (The card controller 1600 terminates the process according to the present embodiment).

(A14) The estimation unit 1630 estimates a temperature variation in the case of applying the combination of the SD-FEC scheme and the HD-FEC scheme extracted in (A10), for the triggered port which is determined to have the margin in (A10). The difference (ΔTₐ_{_}_{UP}) between the environment temperature variations (variations of the surrounding temperature) calculated from power consumptions before and after the change of the FEC schemes, respectively, is the leeward-side environment temperature variation. The estimation unit 1630 adds the leeward-side environment temperature variation (ΔTₐ_{_}_{UP}) to the case temperature and the surrounding environment temperature of each leeward-side module, and the junction temperature and the surrounding environment temperature of each leeward-side framer LSI. Here, the power consumption amounts of the module and the framer LSI corresponding to the SD-FEC scheme and the HD-FEC scheme which are currently being operated are referred to as P@MDL_N_Current and P@LSI_N_Current, respectively. In addition, it is assumed that the power consumption amounts after the change of the SD-FEC scheme and the HD-FEC scheme are P@MDL_N_Change and P@LSI_N_Change, respectively. The leeward-side environment temperature variation is represented by the following equations.

ΔTₐ_{_}_{UP}@MDL_N=f(P@MDL_N_Current)−f(P@MDL_N_Change)

ΔTₐ_{_}_{UP}@LSI_N=f(P@LSI_N_Current)−f(P@LSI_N_Change)
For example, as to a leeward-side port temperature variation when FEC schemes of port N+1 are changed, in a case where a plurality of ports changing the FEC schemes exists, the leeward-side environment temperature variation (ΔTₐ_{_}_{UP}) for each of the changing ports is added at a leeward-side port.

(A15) The estimation unit 1630 estimates a temperature variation when the module and the framer LSI are triggered in the combinations extracted in (A3), for module-unmounted ports, based on a temperature after the change of the FEC schemes estimated in (A14), and determines whether the module and the framer LSI exceed the specified temperature. The process of (A15) will be described in detail later in (B1) to (B10).

(A16) The estimation unit 1630 repeatedly performs the process of (A15) for all the combinations of the FEC schemes extracted in (A3).

(A17) The estimation unit 1630 repeatedly performs the processes of (A15) and (A16) for all the mounted ports with the margin extracted in (A10) and the combinations of the FEC schemes.

(A18) The estimation unit 1630 determines whether an operable port of the module and the framer LSI exists as a result of (A15) to (A17).

(A19) When it is determined in (A18) that there is no usable port, the notification unit 1660 notifies the management terminal 3000 that there is no addible port (The card controller 1600 terminates the process according to the present embodiment).

(A20) When it is determined in (A18) that there is a usable port, the notification unit 1660 notifies the management terminal 3000 of the usable mounted port and the combinations of the FEC schemes. At this time, the notification unit 1660 further notifies a condition that the FEC schemes of the triggered port be also changed. The operator selects triggering contents (e.g., the port or the FEC schemes) from the menus.

(A21) The controller 1640 changes the FEC schemes of the triggered port based on the contents received in (A20) and triggers the added module and operates the framer LSI.

As described above, the line card according to the present disclosure may estimate the combinations of the FEC schemes operated by the framer LSI and the pluggable module, in the range in which the environment temperature inside the device does not exceed the specified temperature. Further, for example, combinations of the FEC schemes considering, for example, an already triggered module, as well as a module to be newly added, may also be estimated.

Subsequently, the process by the estimation unit 1620 in the processes of (A4) and (A15) will be described in detail.

(B1) Herein, it is assumed that a port to be subject to the processes of (A4) and (A15) is a port N. The estimation unit 1620 estimates the module case temperature T_{c}@Pluggable_Module when the module is triggered with the SD-FEC scheme. The module case temperature T_{c}@Pluggable_Module may be estimated by numbers. The estimation unit 1620 uses the various parameters of the thermal coefficient table 3100 (FIG. 3) stored in the memory.

T_{c}@Pluggable_Module_N=Ta@Temp_Sensor_MDL_N+ΔTa@MDL_N+θca@MD L_N*P@MDL_N

(B2) The estimation unit 1620 determines whether the case temperature T_{c}@Pluggable_Module_N at the port N estimated in (B1) exceeds the module specified temperature T_{c}_{_}_{MAX}@MDL. The estimation unit 1620 may obtain the module specified temperature from the specified temperature table 4200 of FIG. 5.

(B3) When it is determined that the case temperature does not exceed the module specified temperature, the estimation unit 1620 estimates an environment temperature variation of a module arranged on the side further leeward than the port N.

ΔTₐ_{_}_{UP}@MDL=f(P@MDL)

(B4) The estimation unit 1620 determines whether the case temperature at each of all ports on the side further leeward than the port N exceeds the module specified temperature T_{c}_{_}_{MAX}@MDL, based on the environment temperature variation estimated in (B3).

(B5) When it is determined that the case temperature at each of all the leeward-side ports does not exceed the module specified temperature, the estimation unit 1620 estimates the junction temperature Tⱼ@Framer_LSI when the framer LSI is operated by the port N and the HD-FEC scheme. The junction temperature may be estimated according to the following equation. The estimation unit 1620 uses the various parameters in the thermal coefficient table 3100 (FIG. 3) stored in the memory.

Tⱼ@Framer_LSI_N=Tₐ@Temp_Sensor_LSI_N+ΔTₐ@LSI_N+θⱼₐ@LSI_N*P@LSI_N

(B6) The estimation unit 1620 determines whether the junction temperature Tⱼ@Framer_LSI_N at the port N estimated in (B5) exceeds the LSI specified temperature Tⱼ_{_}_{MAX}@LSI.

(B7) When it is determined that the junction temperature does not exceed the LSI specified temperature, the estimation unit 1620 estimates the environment temperature variation ΔTₐ_{_}_{UP}@LSI_N of a framer LSI arranged at a port on the side further leeward than the port N.

ΔTₐ_{_}_{UP}@LSI_N=f(P@LSI_N)

(B8) The estimation unit 1620 determines whether the junction temperature at each of all ports on the side further leeward than the port N exceeds the LSI specified temperature, based on the environment temperature variation ΔTₐ_{_}_{UP}@LSI_N estimated in (B7).

(B9) When it is determined that the junction temperature at each of all the leeward-side ports does not exceed the LSI specified temperature, the estimation unit 1620 determines that the port N and the FEC schemes may be used. Thereafter, the card controller 1600 performs the process from (A5).

(B10) When it is determined in the processes of (B2), (B4), (B6), and (B8) that the temperatures exceed the specified temperature, the estimation unit 1620 determines that the port N and the FEC schemes may not be used. Thereafter, the card controller 1600 performs the process from (A5).

Subsequently, the process by the estimation unit 1620 in the process of (A10) will be described in detail.

(C1) Herein, it is assumed that a port to be subject to the process of (A10) is a port X. The collection unit 1620 collects an SD-FEC monitor and an HD-FEC monitor of the port X. Examples of the SD-FEC monitor and the HD-FEC monitor to be collected are described below.

SD-FEC Corrected Bit_X (the number of SD-FEC corrected bits)

SD-FEC Un-Corrected Block_X (the number of SD-FEC un-corrected blocks)

HD-FEC Corrected Bit_X (the number of HD-FEC corrected bits)

HD-FEC Un-Corrected Block_X (the number of SD-FEC un-corrected blocks)

(C2) The estimation unit 1620 estimates the BER before FEC correction from the FEC monitor values collected in (C1) and elapsed time. The estimation unit 1620 estimates, from correction capability, BER after FEC correction in the case of applying a combination of the SD-FEC scheme and an FEC scheme other than the HD-FEC scheme, with respect to BET before the estimated FEC correction.

(C3) The card controller stores the combination of the SD-FEC scheme and the HD-FEC scheme satisfying the transmission quality in a memory and continuously performs the process from (A11).

In addition, the module according to the present disclosure is not limited to the SFP, the XFP, or the CFP. In addition, various types of modules may exist together on the line card. In the present disclosure, the temperature sensors are provided near the module and the framer LSI. However, the positions of the temperature sensors are not limited.

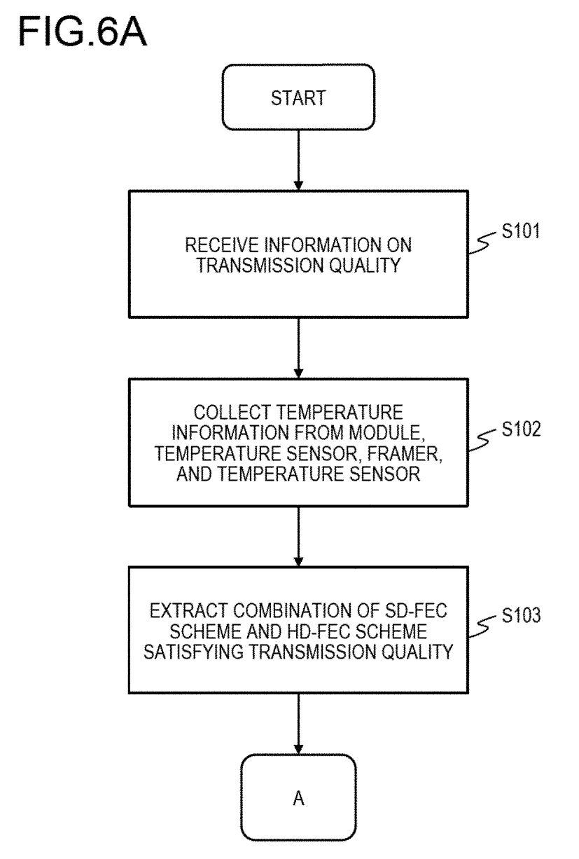

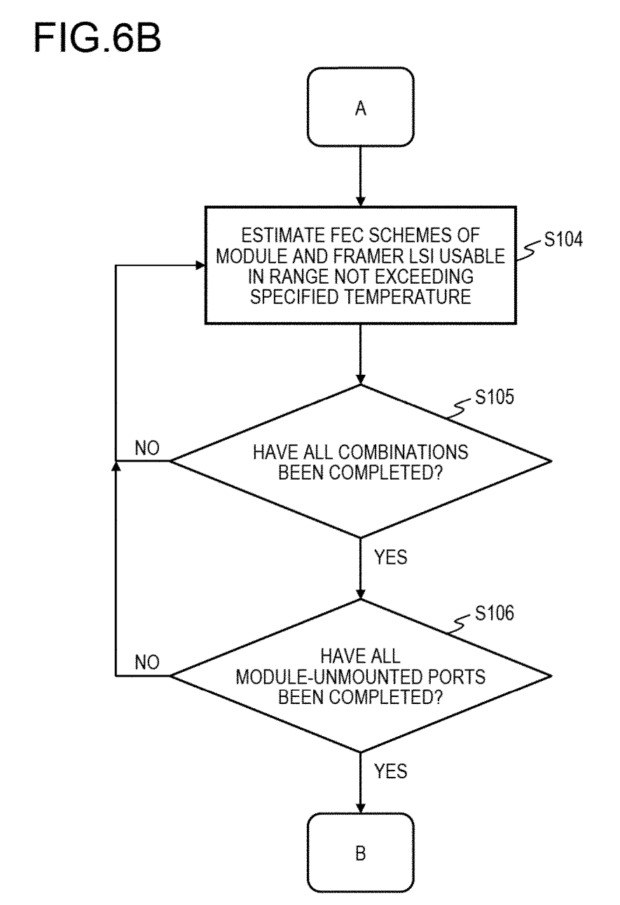

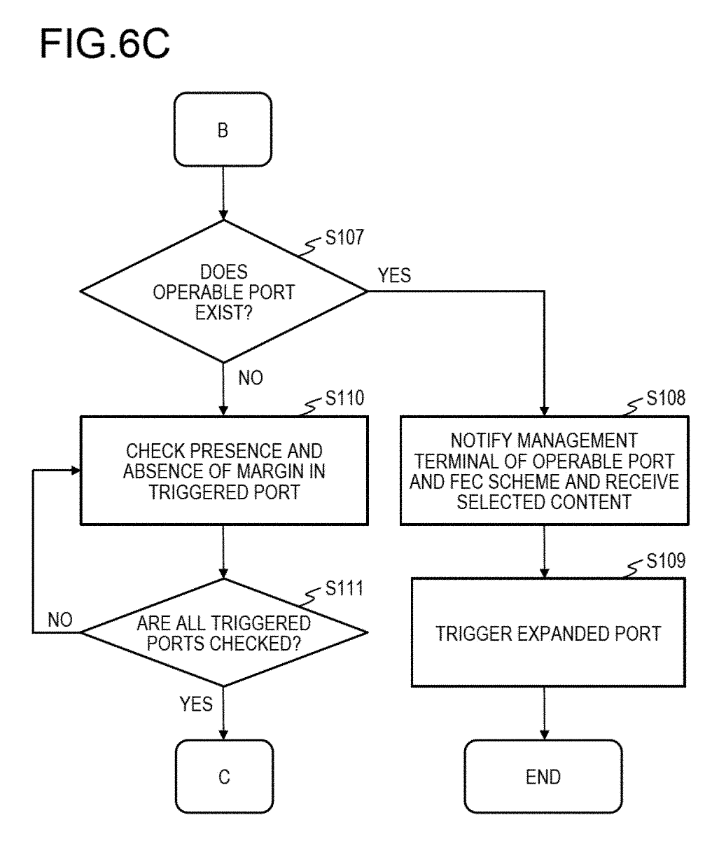

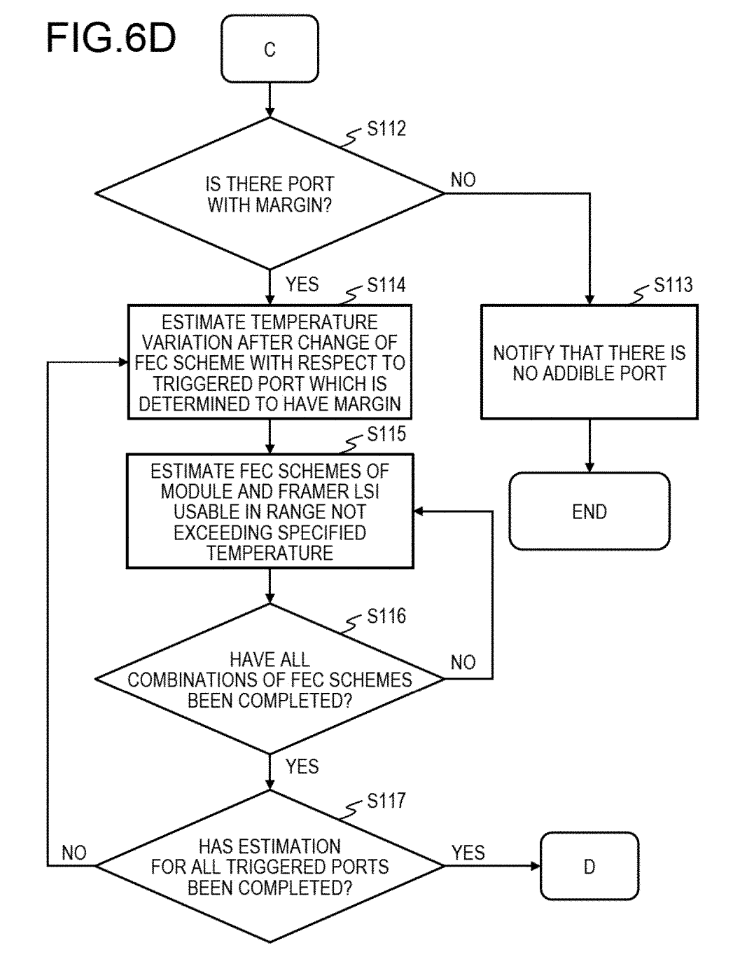

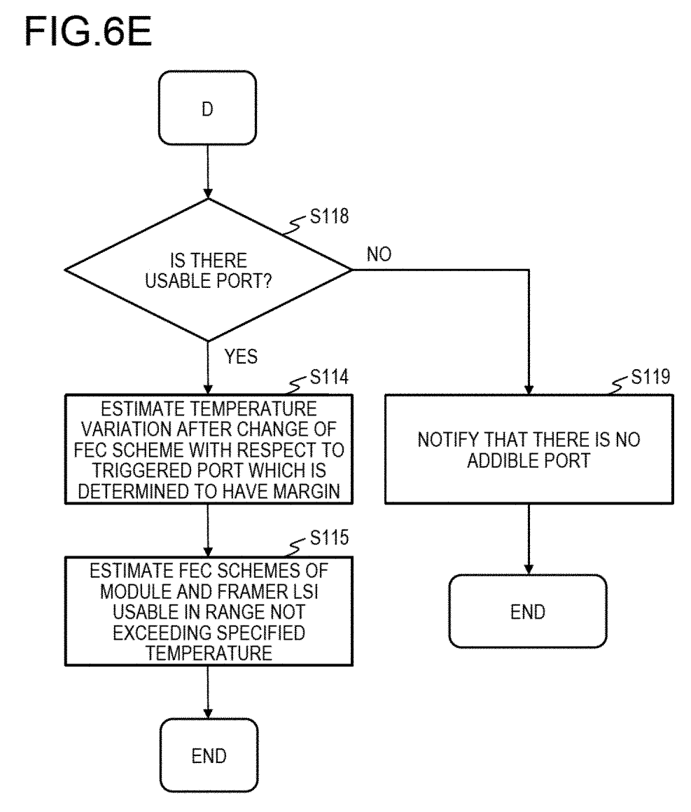

FIGS. 6A to 6E are flowcharts for describing the process by the card controller according to the present disclosure. When a module is newly added, the reception unit 1610 within the line card controller 1600 controlling the line card 1000 receives information on a transmission quality required for a service or a system, from the management terminal 3000 (operation S101). The collection unit 1620 collects temperature information from various modules such as each module, a temperature sensor near the module, the framer LSI 1300, and a temperature sensor near the framer LSI (operation S102). The extraction unit 1650 extracts the combinations of the SD-FEC scheme and the HD-FEC scheme satisfying the transmission quality (operation S103).

The estimation unit 1630 estimates the FEC schemes of a module and a framer LSI which are usable in the range that does not exceed the specified temperature, for the extracted combinations of the FEC schemes and module-unmounted ports (operation S104). The estimation unit 1630 determines whether the process of operation S104 has been performed for all the combinations extracted in operation S103 (operation S105). When it is determined that the process of operation S104 has not been performed for all the extracted combinations (No in operation S105), the estimation unit 1630 repeatedly performs the process from operation S104. When it is determined that the process of operation S104 has been performed for all the extracted combinations (YES in operation S105), the estimation unit 1630 determines whether the processes of operation S104 and operation S105 have been completed for all the module-unmounted ports (operation S106).

The estimation unit 1630 determines whether an operable port of the module 5 and the framer LSI 1300 exists, based on the results of operations S104 to S106 (operation S107). When it is determined that an operable port exists (YES in operation S107), the notification unit 1660 notifies the management terminal 3000 of all the usable port and the combinations of the FEC schemes, and receives an input of triggering contents (a port and an FEC scheme to be used) from an operator (operation S108). The controller 1640 triggers the module and the framer LSI according to instruction contents (a port and an FEC scheme to be used) received from the operator in operation S108 (operation S109). When the process of operation S109 is completed, the card controller 1600 terminates the process according to the present disclosure.

When it is determined that no operable port exists (NO in operation S107), the estimation unit 1630 checks the presence/absence of a margin for the transmission quality, for module-triggered ports (operation S110). Further, in the process of operation S110, the extraction unit estimates the combinations of changeable SD-FEC schemes and HD-FEC schemes in the range in which the requirement for the transmission quality is satisfied in the corresponding ports. The estimation unit 1630 determines whether the process of operation S110 has been performed for all the module-triggered ports (operation S111). When it is determined that the process of operation S110 has not been performed for all the module-triggered ports (No in operation S111), the estimation unit 1630 repeatedly performs the process from operation S111.

When it is determined that the process of operation S110 has been performed for all the module-triggered ports (YES in operation S111), the estimation unit 1630 determines whether a module-triggered port which has the margin of the transmission quality exists (operation S112). When it is determined that there is no module-triggered port which has the margin of the transmission quality (NO in operation S112), the notification unit 1660 notifies the management terminal 3000 that there is no addible port (operation S113). When the process of operation S113 is completed, the card controller 1600 terminates the process according to the present embodiment.

When it is determined that there is a module-triggered port which has the margin of the transmission quality (YES in operation S112), the estimation unit 1630 estimates a temperature variation in the case of applying the combination of the SD-FEC scheme and the HD-FEC scheme extracted in operation S110, for the triggered port which is determined to have the margin (operation S114). The estimation unit 1630 estimates a temperature variation when the module and the framer LSI are triggered in the combinations extracted in operation S103, for module-unmounted ports based on the temperature after the change of the FEC schemes, and determines whether the module and the framer LSI exceed the specified temperature (operation S115). The estimation unit 1630 determines whether the process of operation S115 has been performed for all the combinations of the FEC schemes extracted in operation S103 (operation S116). When it is determined that the process of operation S115 has not been performed for all the combinations of the FEC schemes extracted in operation S103 (No in operation S116), the estimation unit 1630 selects another combination of the FEC schemes and repeatedly performs the process from operation S115. When it is determined that the process of operation S115 has been performed for all the combinations of the FEC schemes extracted in operation S103 (YES in operation S116), the estimation unit 1630 determines whether the processes of operation S114 and operation S115 have been completed for all the mounted ports with the margin which are extracted in operation 5110 (operation S117). When it is determined that the processes of operation S114 and operation S115 have not been completed for all the mounted ports with the margin (NO in operation S117), the estimation unit 1630 repeatedly performs the process from operation S114 for other mounted ports with the margin.

The estimation unit 1630 determines whether an operable port of the module and the framer LSI exists, based on the results of operations S115 to S117 (operation S118). When it is determined that there is no operable port (NO in operation S118), the notification unit 1660 notifies the management terminal 3000 that there is no addible port (operation S119). The card controller 1600 terminates the process according to the present embodiment. When it is determined that a usable port exists (YES in operation S118), the notification unit 1660 notifies the management terminal 3000 of the usable mounted port and the combinations of the FEC schemes (operation S120). The controller 1640 changes the FEC schemes of the triggered port according to an input of an operator on the side of the management terminal 3000 and triggers the added module and operates the framer LSI (operation S121).

As described above, the line card according to the present disclosure may estimate the combinations of the FEC schemes operating by a framer LSI and a pluggable module, in the range in which the environment temperature inside the device does not exceed the specified temperature. Further, the combinations of FEC schemes considering, for example, an already triggered module, as well as a module to be newly added, may also be estimated.

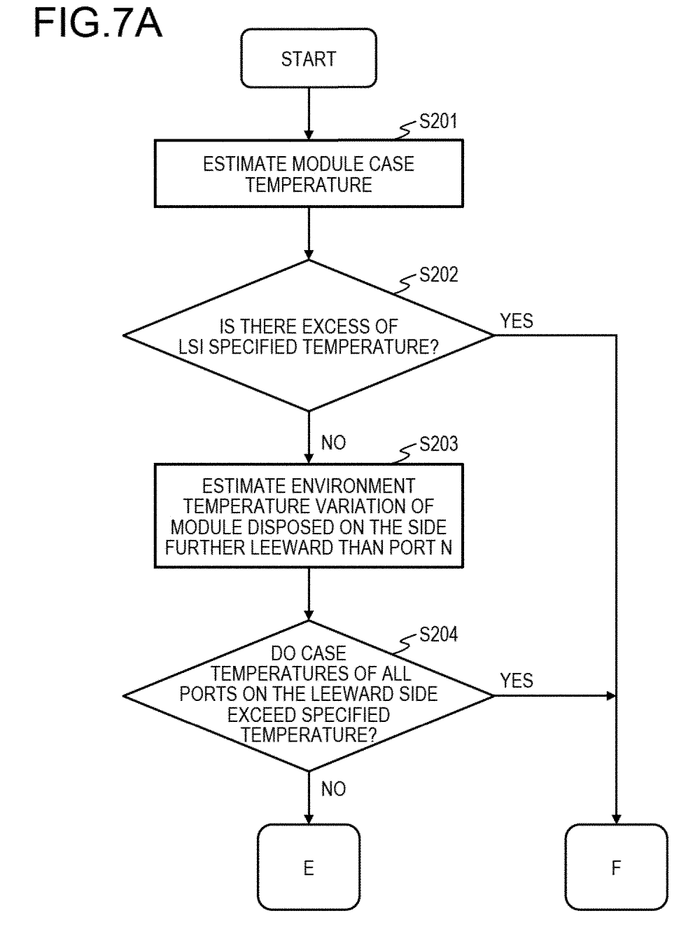

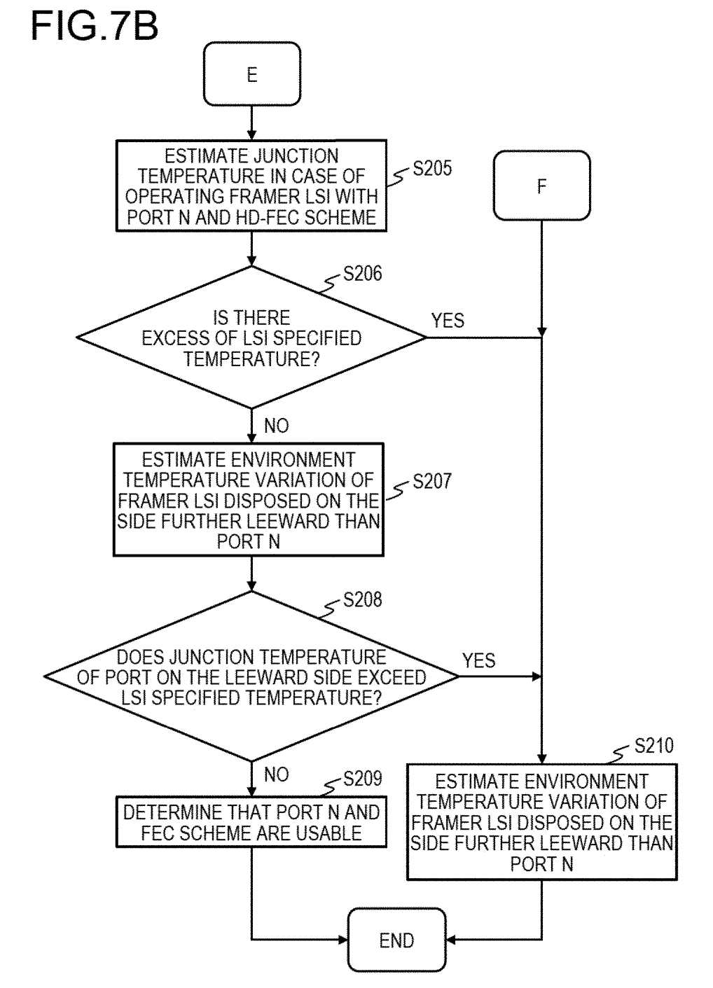

FIGS. 7A and 7B are flowcharts for describing an example of the process by the estimation unit. The flowcharts of FIGS. 7A and 7B are an example of the specific processes of operations S104 and S115. The estimation unit 1620 estimates the module case temperature T_{c}@Pluggable_Module in the case of triggering the module with the SD-FEC scheme (operation S201). The estimation unit 1620 determines whether the module case temperature exceeds the module specified temperature (operation S202). When it is determined that the module case temperature does not exceed the module specified temperature, the estimation unit 1620 estimates the environment temperature variation of a module arranged on the side further leeward than the port N (operation S203). The estimation unit 1620 determines whether the case temperature at each of all ports on the side further leeward than the port N exceeds the module specified temperature, based on the environment temperature variation estimated in operation S203 (operation S204).

When it is determined that the case temperature at each of all the leeward-side ports does not exceed the module specified temperature (NO in operation S204), the estimation unit 1620 estimates the junction temperature when the framer LSI is operated at the port N and in the HD-FEC scheme (operation S205). The estimation unit 1620 determines whether the junction temperature T@Framer_LSI_N at the port N estimated in operation S205 exceeds the LSI specified temperature Tⱼ_{_}_{MAX}@LSI (operation S206). When it is determined that the junction temperature does not exceed the LSI specified temperature (NO in operation S206), the estimation unit 1620 estimates the environment temperature variation ΔTₐ_{_}_{UP}@LSI_N of a framer LSI arranged at a port on the side further leeward than the port N. (operation S207). The estimation unit 1620 determines whether the junction temperature at each of all ports on the side further leeward than the port N exceeds the LSI specified temperature (operation S208). When it is determined that the junction temperature at each of all the leeward-side ports does not exceed the LSI specified temperature (NO in operation S208), the estimation unit 1620 determines that the port N and the FEC schemes may be used (operation S209). Thereafter, the card controller 1600 terminates the processes of FIGS. 7A and 7B and performs the processes from operations S105 and S116.

When it is determined that the module case temperature exceeds the module specified temperature (YES in operation S202), or the case temperature at each of all ports on the side further leeward than the port N exceeds the module specified temperature (YES in operation S204), the estimation unit 1620 determines that the port N and the FEC schemes may not be used (operation S210). Further, when it is determined that the junction temperature at the port N exceeds the LSI specified temperature (YES in operation S206), or the junction temperature at each of all ports on the side further leeward than the port N exceeds the LSI specified temperature (YES in operation S208), the estimation unit 1620 performs the process of operation S210.

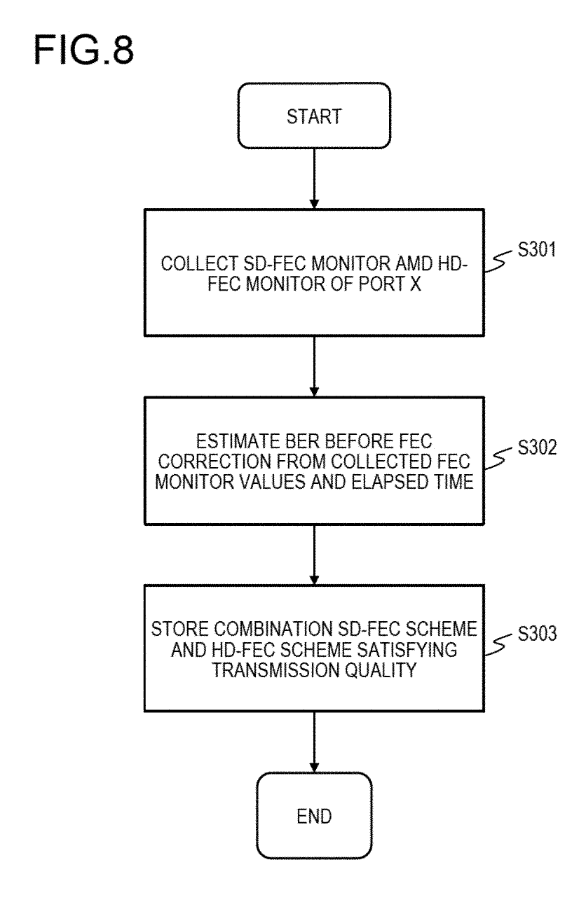

FIG. 8 is a flowchart for describing an exemplary method of extracting the FEC schemes satisfying the transmission quality. FIG. 8 is a flowchart for specifically describing the process of operation 110 of FIG. 7B. The collection unit 1620 collects the SD-FEC monitor and the HD-FEC monitor of the port X (operation S301). The estimation unit 1620 estimates the BER before the FEC correction from the collected FEC monitor values and elapsed time (operation S302). The card controller stores a combination of the SD-FEC scheme and the HD-FEC scheme satisfying the transmission quality in a memory and continuously performs the process from operation S111 (operation S303).

As described above, the line card according to the present disclosure may estimate the combinations of the FEC schemes operated by a framer LSI and a pluggable module, in the range in which the environment temperature of the device does not exceed the specified temperature. Further, the combinations of FEC schemes in consideration of, for example, an already triggered module, as well as a module to be newly added, may also be estimated. Therefore, in the line card on which various types of different pluggable modules are mounted, by monitoring the temperature on the line card and selecting the FEC schemes, mounting/arrangement suitable for a practical operation may be implemented. Further, it is possible to determine whether an unmounted pluggable module is mounted or implement an optical transmission suitable for practical operation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A line card configured to mount a module in which a signal transmitted on a line is processed, the line card comprising:
a memory: and
a processor coupled to the memory and the processor configured to:
receive information on transmission quality of the signal to be transmitted through the module to be mounted on the line card,
extract a combination satisfying the transmission quality among combinations of error correction processing schemes applicable to the module and a framer circuit for performing a signal processing for the signal to be transmitted, and
estimate a combination of a range in which temperatures of each of the module and the framer circuit do not exceed a predetermined temperature when the module and the framer circuit are operated by applying the error correcting processing schemes of the combination extracted.

2. The line card according to claim 1,
wherein the processor is further configured to:
estimate a temperature variation of the module arranged on leeward according to a temperature of the module arranged on windward,
estimate a temperature variation of the framer circuit arranged on the leeward according to a temperature of the framer circuit arranged on the windward, and
estimate a combination of error correction processing schemes operable in a range in which temperatures of the module arranged on the leeward and the framer circuit arranged on the leeward do not exceed the predetermined temperature.

3. A control method of a line card configured to mount a module in which a signal transmitted on a line is processed, the control method comprising:
receiving information on transmission quality of the signal to be transmitted through the module to be mounted on the line card;
extracting a combination satisfying the transmission quality among combinations of error correction processing schemes applicable to the module and a framer circuit for performing a signal processing for the signal to be transmitted; and
estimating a combination of a range in which temperatures of each of the module and the framer circuit do not exceed a predetermined temperature when the module and the framer circuit are operated by applying the error correcting processing schemes of the combination extracted, by a processor.

4. The control method according to claim 3, further comprising:
estimating a temperature variation of the module arranged on leeward according to a temperature of the module arranged on windward;
estimating a temperature variation of the framer circuit arranged on the leeward according to a temperature of the framer circuit arranged on the windward; and
estimating a combination of error correction processing schemes operable in a range in which temperatures of the module arranged on the leeward and the framer circuit arranged on the leeward do not exceed the predetermined temperature.

5. A computer-readable non-transitory recording medium storing a program that causes a computer to execute a procedure, the procedure comprising:
receiving information on transmission quality of a signal to be transmitted through a module to be mounted on a line card;
extracting a combination satisfying the transmission quality among combinations of error correction processing schemes applicable to the module and a framer circuit for performing a signal processing for the signal to be transmitted; and
estimating a combination of a range in which temperatures of each of the module and the framer circuit do not exceed a predetermined temperature when the module and the framer circuit are operated by applying the error correcting processing schemes of the combination extracted.
